(19) United States
(12) Patent Application Publication
(10) Pub. No.: US 2024/0362016 A1
(43) Pub. Date: Oct. 31, 2024

(54) Git Commit Registry

(71) Applicant: SAP SE, Walldorf (DE)

(72) Inventors: Dirk Ganzke, Reilingen (DE); Martin Bredy, Brühl (DE); Iwan Kostin, Sankt Leon-Rot (DE)

(21) Appl. No.: 18/309,481

(22) Filed: Apr. 28, 2023

(51) Int. Cl. G06F 8/70; G06F 8/30; G06F 8/60

(52) U.S. Cl. CPC G06F 8/70; G06F 8/30; G06F 8/60

(57) ABSTRACT

Embodiments implement a central commit registry to ensure integrity of code within a Git repository, and compliance of that code with requirements of a computing platform. Commits out of the platform are registered in the central commit registry, together with a content hash. Prior to importing code to the platform from the Git repository, commits between the current and target commit are checked against commits recorded in the central commit registry. Import of code to the platform from the Git repository is rejected, if a commit is found that is not registered or where the content hash does not match. Embodiments facilitate using Git repositories as channels for delivering code to platforms, ensuring safe/compliant import of extensions drafted by parties (e.g., customers; partners) outside the platform. Such external parties are thus able to use their own Git repositories for development, testing, and/or deployment of code that they have prepared.

### BACKGROUND

Unless otherwise indicated herein, the approaches described in this section are not prior art to the claims in this application and are not admitted to be prior art by inclusion in this section.

A vendor may develop a complex software platform that manages a variety of functions (e.g., business operations; customer relations; resource management). Such software, however, may not address all specific needs of a particular customer of the vendor.

Accordingly, the customer may engage third party developer to create tailored solutions that address specific needs (e.g., are relevant to certain industries, countries). Such customizations, however, must comply with the original platform in order to prevent undesirable failures affecting reliability.

### SUMMARY

Embodiments implement a central commit registry to ensure integrity of code within a Global information tracker (Git) repository, and the compliance of that code with the requirements of a particular computing platform. Commits out of the platform are registered in the central commit registry, together with a content hash. Prior to importing code to the platform from the Git repository, commits between the current and target commit are checked against commits recorded in the central commit registry. Attempted import of code to the platform from the Git repository is rejected, if a commit is found that is not registered or where the content hash does not match. In this manner, embodiments facilitate the use of external Git repositories as channels for delivering code to platforms, thereby allowing the safe/compliant import of extensions drafted by parties (e.g., customers; partners) outside the platform. Moreover, the external parties are able to use their own Git repositories for development, testing, and/or deployment of code that they have prepared.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIG. 3 shows a simplified diagram of a system according to an example.

FIG. 4 shows a Git commit call sequence according to the example.

FIG. 5 shows a Git commit pull sequence according to the example.

FIG. 6 shows a detailed view of the architecture according to the example.

FIG. 7 shows a commit procedure on a source system according to the example.

FIG. 8 shows a deploy procedure on a target system according to the example.

FIG. 9 illustrates hardware of a special purpose computing machine configured to implement a code commit registry according to an embodiment.

FIG. 10 illustrates an example computer system.

### DETAILED DESCRIPTION

Described herein are methods and apparatuses that implement a code commit registry. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

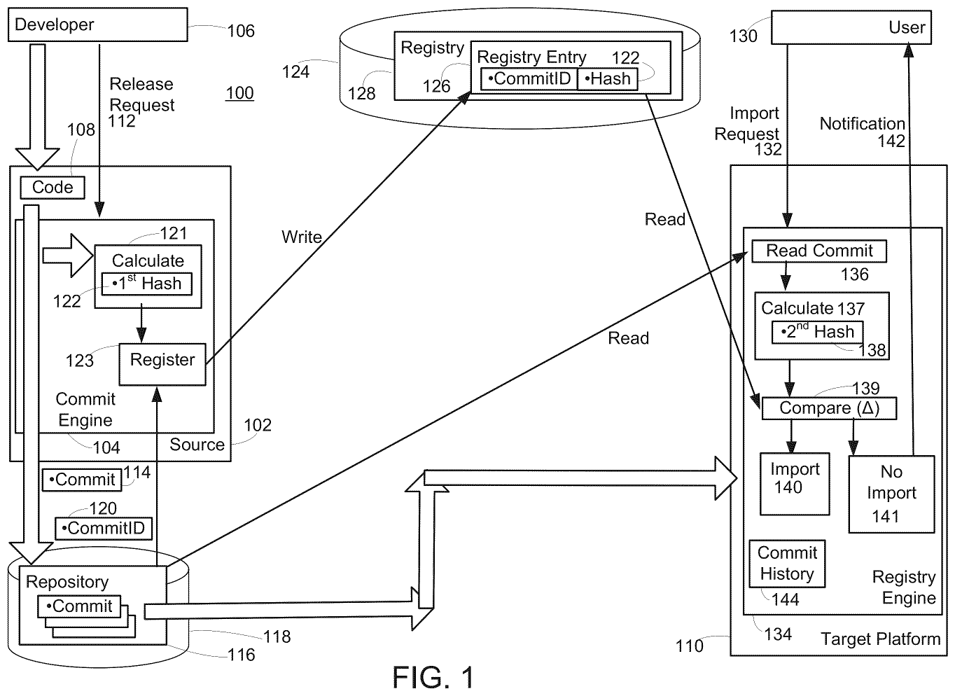

FIG. 1 shows a simplified view of an example system that is configured to implement a code commit registry according to an embodiment. Specifically, system 100 comprises a source 102 including a commit engine 104.

A developer 106 has previously been in communication with the source to draft code 108 for operation on a target platform 110. Now, the source receives a request 112 to store a commit 114 comprising at least a portion of that code to a repository 116, for later deployment into the target platform.

Accordingly the commit is stored in the repository of a first non-transitory computer readable storage medium 118. The commit may include not only code that is to be imported to the target platform, but also identifier information (e.g., of the source system and/or of a particular developer).

A commit identifier 120 is returned from the repository to the source. The source stores the commit identifier.

The commit engine calculates 121 a first, registry hash 122 from the content of the commit. Then, that registry hash and with the corresponding commit ID are registered 123 to a second non-transitory computer readable storage medium 124.

Specifically, the registry hash and the commit ID are stored together as a registry entry 126 within registry 128. That storage may take the form of data objects in a relational database.

Next, the target platform receives from a user 130, a request 132 to import the commit from the repository. In response, the registry engine 134 reads 136 the commit from the repository.

From the content of the commit that has been read from the repository, the registry engine calculates 137 a second, local hash 138 in the same manner as the registry hash. The registry engine then compares 139 the registry hash with the local hash.

If the registry hash and the local hash are the same, then the target platform can be assured of the integrity of the commit that is present within the repository. Then, the commit is imported 140 to the target platform for execution.

If however, the registry hash and the local hash are not the same, then there may be a problem with the commit. For example, from a security standpoint a malicious actor may have gained access to the repository. Alternatively, from a platform compatibility standpoint a non-malicious actor (e.g., customer) may have sought to later change the commit without the developer's knowledge or approval.

In the event that a problem is encountered, import of the commit to the target platform will not proceed 141. A notification 142 could be sent to the user alerting them to the potential issue. The alert may include ticket information (e.g., offering ticket-based access to authorized support staff).

In addition to comparing the registry hash and the local hash, the registry engine may also reference other information. For example, the registry engine may consider a stored commit history 144. Such commit history data (e.g., commit time; committing party; and/or previous commit content) could aid the registry engine in understanding whether a commit is unmodified and hence proper to import.

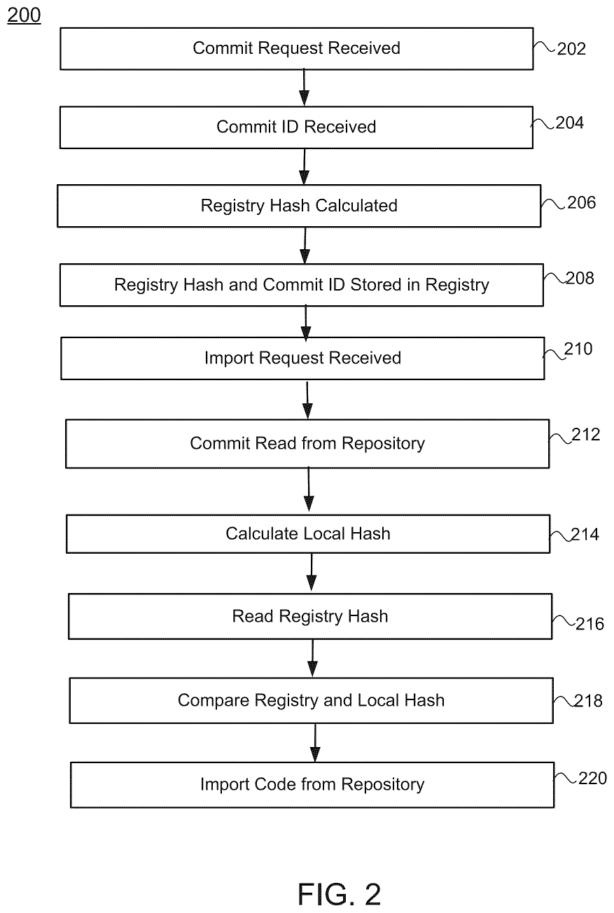

FIG. 2 is a flow diagram of a method 200 according to an embodiment. At 202, a deploy request is received.

At 204, a commit identifier is received from a repository. At 206, a registry hash is calculated.

At 208, the commit identifier and the registry hash are stored in the commit registry.

At 210, an import request is received. At 212, the commit is read from the repository. At 214, a local hash is calculated from the commit.

At 216, the registry hash is read from the registry. At 218, the registry hash and the local hash are compared.

At 220, the commit is imported if the registry hash and the local hash match.

Further details regarding implementation of a code commit registry according to various embodiments, are now provided in connection with the following example. The approach of this example, combines data and information from different tools available from SAP SE of Walldorf, Germany (“SAP”). In particular, this example describes an enhancement to the SAP Git-enabled Change and Transport System (gCTS) that is used to import Global Information Tracker (Git) commits.

### Example

SAP develops enterprise software to manage business operations and customer relations. Such software may not address all customer-specific requirements. Accordingly, partner vendors to SAP may develop further solutions that are specific to particular customer needs (e.g., to certain industries, regions, and other considerations).

The SAP S/4HANA Cloud ABAP Environment requires that certain compliance rules be followed by code operating thereon. Thus, coding that is committed to a Git repository by a third party from the customer or partner system which is intended to be deployed in SAP S/4HANA Cloud, is required to follow those compliance rules.

Accordingly, this exemplary embodiment includes a central commit registry to ensure integrity and SAP compliance of ABAP content in customer or partner Git Repositories. This allows using Git Repositories as a delivery channel, and facilitates partner scenarios such as the safe import of partner extensions into SAP customer S/4HANA Public Cloud Systems.

Code commits out of the SAP S/4HANA Cloud, ABAP environment are registered, together with a content hash. Before the import, commits between the current and target commit are checked against the commits recorded in the commit registry. The import is rejected if a commit is found that is not registered, or where the content hash does not match. A corresponding error message may be raised.

The commit registry according to embodiments, allows SAP customers to use own Git repositories including own Continuous Integration (CI) processes for their cloud development. This reduces costs and complexity on SAP side, and offers customer and partners their own Git repository for use in development, testing, and/or deployment.

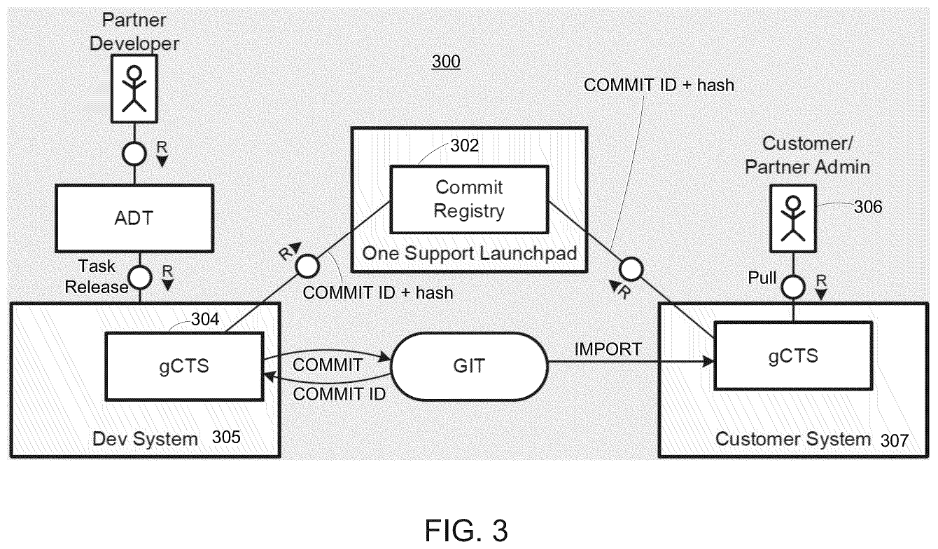

FIG. 3 shows a simplified view of an architecture 300 that integrates a commit registry 302 in the Git based software lifecycle. A gCTS 304 of the source (developer) system 305 registers the successful commit together with a content hash.

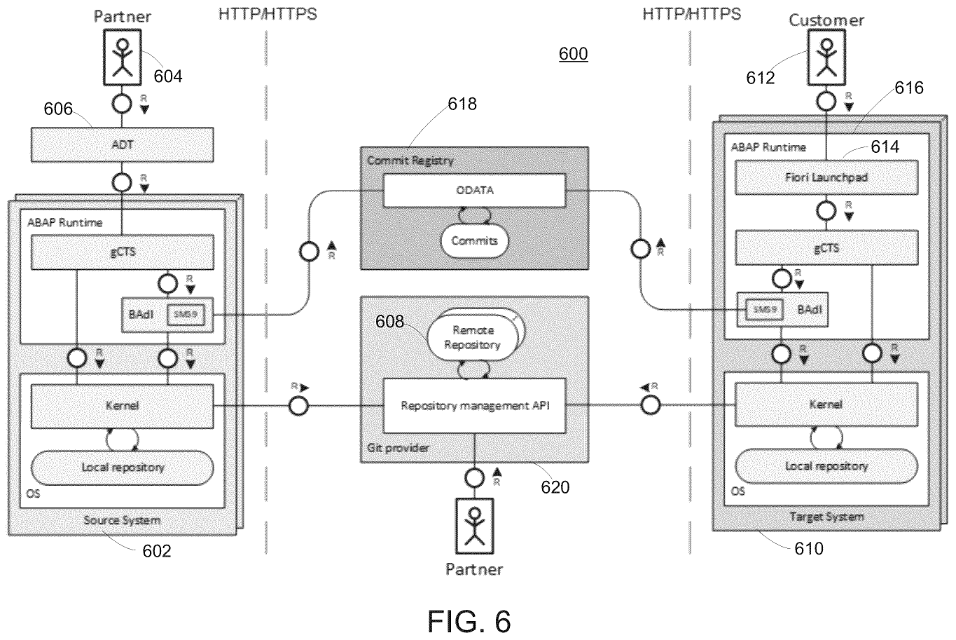

Commits between a current and a target commit of a customer system 307, are checked whether they exist in the commit registry, and whether the content hash is valid. Access to the git commit registry may be established via ODATA Services (shown, e.g., in FIG. 6) and a common technical user 306.

Details regarding the commit registry according to this exemplary embodiment, are now described. In addition to header-level metadata (e.g., date when added), the commit registry table includes following fields:
Repository (key)
Commit ID (key)
Content Hash
SID
   Administration data such as last change user, and time stamp, may also be present.

An internal view allows displaying, creating, and/or changing entries for SAP support. This facilitates registering manual commits after a check by SAP.

The commit repository may handle 1000+ requests per day. Clean-up activities (e.g., deletion of requests not checked for more than 1 year) can be implemented.

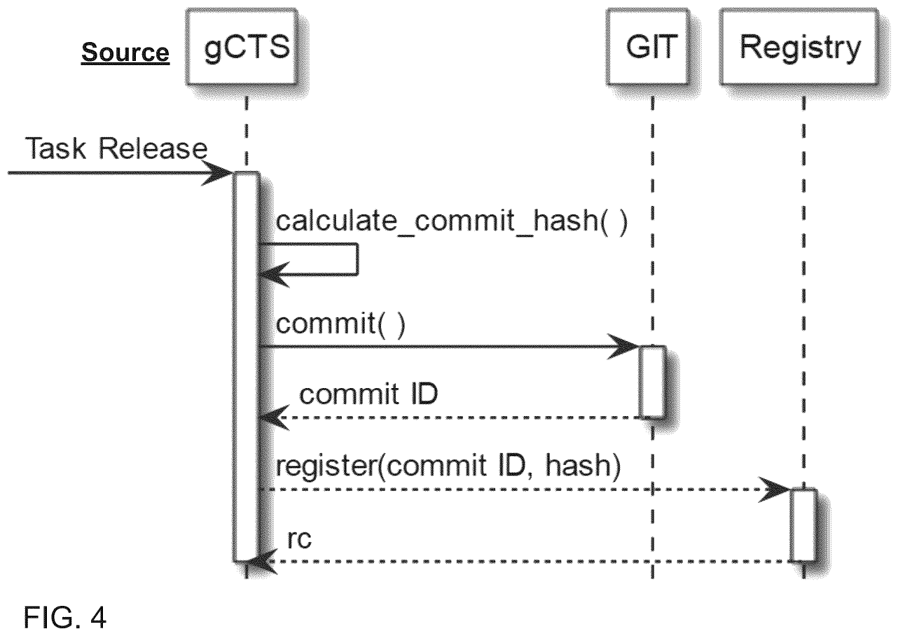

A Git Commit call sequence is shown in FIG. 4. Here, gCTS calculates a registry content hash so that later content changes (manipulation) can be identified. After a successful Git Commit, the Commit is registered together with the content hash in the central Git Commit Registry.

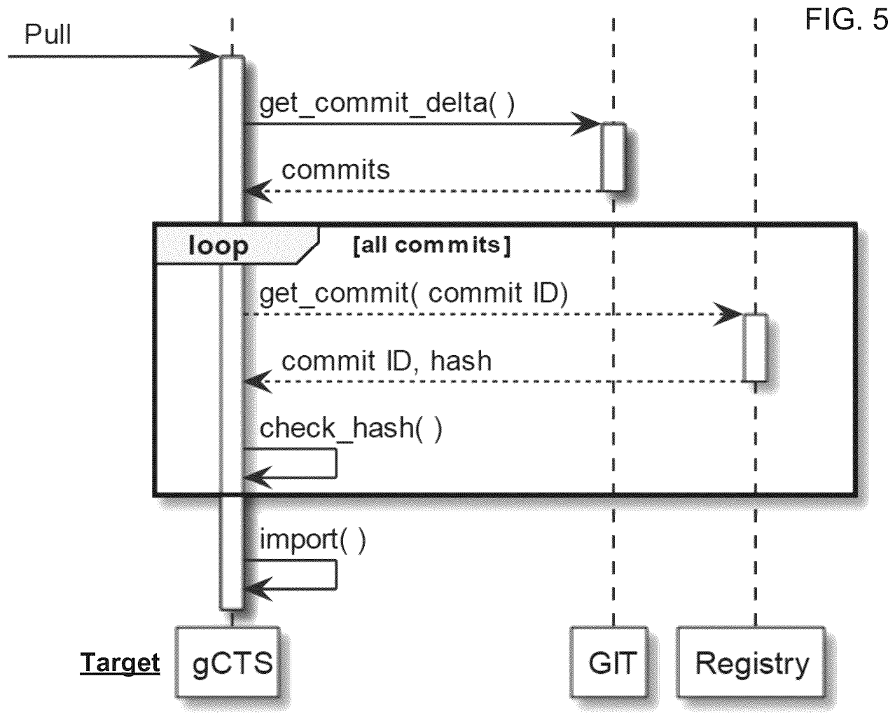

A Git Pull call sequence is shown in FIG. 5. Before an import, the Commit Delta between a current commit and a target commit is determined. Commits are checked whether they already exist in the central registry, and whether the content hash is still valid.

If commits satisfy these conditions, then the actual import happens. Otherwise an error message will be raised and no import occurs.

As previously mentioned, this exemplary embodiment is integrated with the SAP gCTS process. A software lifecycle end-to-end use case, would involve deployment of content from a source system to a target system.

There are several ways this could be realized. One goal of gCTS is to represent a harmonized lifecycle process that fits existing market solutions, and can be easily integrated.

For this reason, a lightweight software deployment mechanism may be desirable to reduce costs and afford an easily consumable solution for customers and partners.

A basic process for committing content by using gCTS, has various endpoints and enhancement spots. These can be extended with maintained configuration as well as logical code implementation.

These enhancements can be used to automatically register commits. The enhancements may hide the registration process in the backend system in order to avoid unwanted manipulation from end user side.

FIG. 6 shows a detailed view of a system 600 integrating a commit registry with gCTS according to this example. FIG. 6 shows four (4) major actors influencing the end-to-end process.

A first actor shown in FIG. 6 is the source system 602. This system is mostly used by partners 604 to develop and maintain new applications.

Once development is finished, ABAP Development Tools (ADT) 606 are used to release a transport request. This request leads to a new commit in the related repository 608.

A second actor in FIG. 6 is the target system 610. This system is mostly used by customers 612 who consume partner applications. A GCTS Fiori app 614 may be used to deploy a new version of a partner application to ABAP runtime.

A third actor in FIG. 6 is the commit registry 618. This software application will be used to track new commits in the repository, and to evaluate those commits for further processing decisions.

A fourth actor in FIG. 6 is the Git Provider 620. This platform can be hosted by partners. It provides common git functionalities, such as remote repositories for source code versioning.

The partner can potentially interact with Source System and Git provider. The customer will consume remote repositories as deployment channels for its own environment.

The Git provider may be hosted by SAP or by a partner. Developers (or other users of customer/partner) have access to Source and Target system, and can interact with end user transactions and apps such as SAP Fiori Launchpad or ADT. Direct access to ABAP backend (SAP GUI Access) is not needed and may not be granted to an end user.

After development and customizing activities are finalized by a partner, gCTS will be automatically started by releasing transport requests. This in turn triggers the basic gCTS process according to the following general steps:
Evaluation,
Conversion,
Committing,
Promoting.

Enhancement of gCTS takes place between Committing and Promoting. This is because the new commit id is known, and the internal ABAP thread is still running. There is usually no technical interaction for the end user. The enhancement logic will start after finishing the Committing phase.

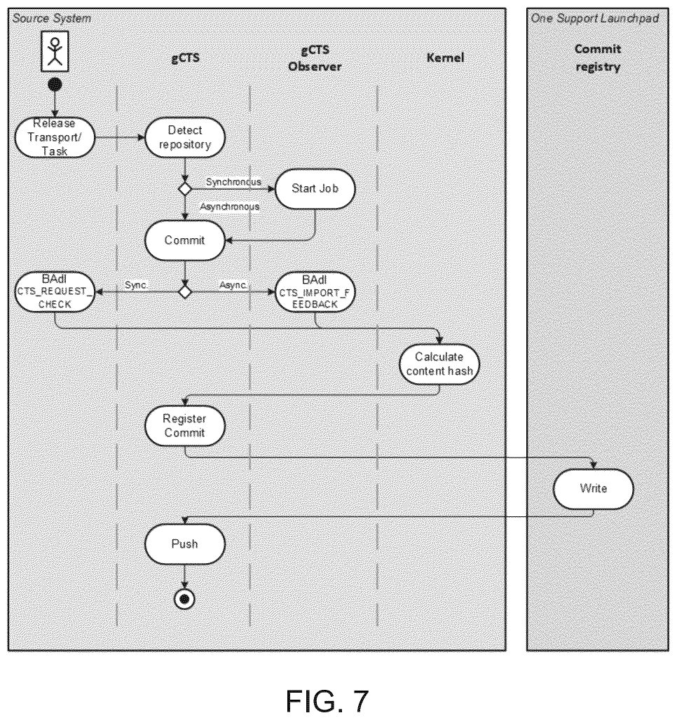

FIG. 7 shows an overview of a commit procedure on a source system. As shown here, there are two different possible strategies of committing:
Synchronous commit
Asynchronous commit

The raw business logic is similar for both strategies from a technical point of view. However, the process flow is different which also involves an enhancement adjustment for the execution of a commit registry.

In this particular example, a SM59 connection (shown in FIG. 6) will be used for interaction with the Commit Registry and have the same security level as other connectivity scenarios which make use of SM59 connections. The end user may not communicate with the Commit Registry, which is accessible by enhancement logic without any UI or HTTP service capability.

The enhancement logic follows the following procedure in the Source System:
create commit and return commit ID from git client;
calculate differences between previous and current commit;
specify involved file-based content in local repository located on file system of OS;
calculate file checksum (e.g., with SHA-1 algorithm) for involved files;
consolidate all checksums into one checksum;
collect commit registration meta information;
   Local repository ID
   Remote repository URL
   Git Commit ID
   File Checksum
Send to Commit Registry.

If this procedure can be successfully executed, local commit will be accepted in gCTS. The push action will proceed in git client.

If the procedure cannot be successfully executed, the process stops and gCTS rejects the commit as invalid. No push action is executed in this case, and a new commit will not be globally promoted.

Once the commit has arrived in the remote repository, the end user/customer/partner can deploy it for import to the Target System. This can be done by using a gCTS Fiori app in the SAP Fiori Launchpad, by cloning/pulling wanted repository.

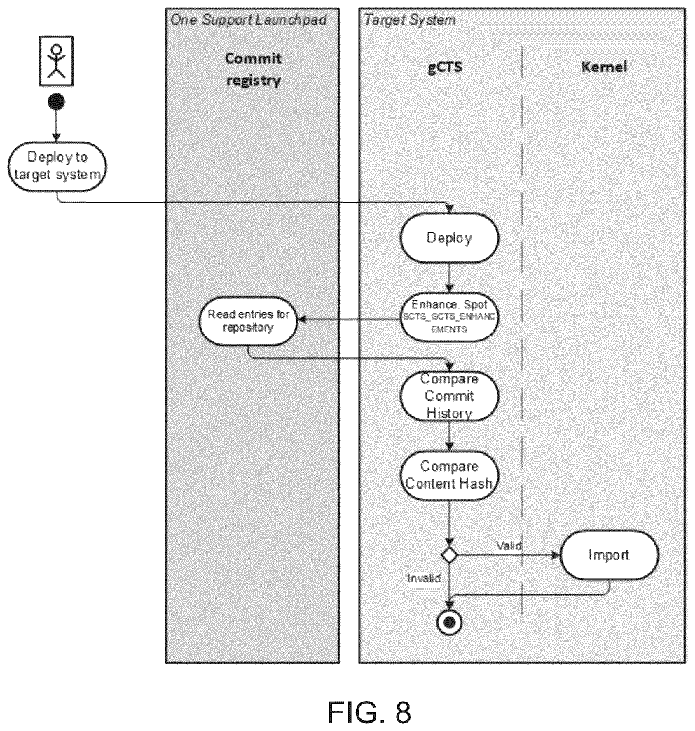

FIG. 8 shows a flow of a default deploy procedure on the target system. This starts in gCTS, which calculates delta differences between active and target commit.

Additionally, the history path will be stored for further procedures, such as:
Commit 4 (Selected commit for deployment)
Commit 3
Commit 2
Commit 1 (Active commit in Target System)
   Therefore, commit 2/3/4 will be kept as history path.

The deployment can also be enhanced with an enhancement spot SCTS_GCTS_ENHANCEMENTS and will be called right before the commit content will be imported into the ABAP runtime (Target System).

This validation action follows the following procedure:
Read local commit details
Calculate file checksum for involved files
Compare local information with Commit registry information
(Advanced) Read history path
(Advanced) Repeat ‘local commit’ procedure for every commit in history path.

If checks can be successfully executed, the deployment procedure will continue. The commit content will be imported into ABAP runtime.

If one check was not successfully checked, deployment procedure will be interrupted, and an exception will be shown to end user. In such case, the repository cannot be deployed anymore and needs to be approved by SAP again.

In the event of an invalid commit, the customer/partner should run an evaluation process. For this approach, the repository can be cloned to an isolated ‘build environment’ which will be provided for evaluation only.

The potential invalid content will be imported, and ATC and ABAP Language (e.g., Version 5) checks can be executed. If everything is valid, the repository will be approved and registered again. Otherwise, the customer/partner must correct the content of the repository until content violations are solved.

System provisioning can be separated into three (3) different ⋅phases as follows:
gCTS preparation (Done by task list)
will set the basic configuration such as preparation of basic TMS configuration, gCTS workspace directory, definition of JRE and schedule of gCTS Observer Job
Commit Registry preparation (Done by task list)
activation of BAdI and particular process enhancements for transparent integration
gCTS repository preparation (Done by end user—e.g., partner)
providing credentials for Git provider in gCTS app
creation of repository
cloning of repository
(Optional) usage of git branch concept.

The following are specific configuration ⋅phases to setup the ‘Commit Registry’ approach on partner/source system:
Repository clone of BAdI logic since it is not part of software component SAP_BASIS
Endpoint ‘CTS_REQUEST_CHECK’ or ‘CTS_TRANSPORT_FLOW’ for synchronous commit
Endpoint ‘CTS_IMPORT_FEEDBACK’ for asynchronous commit
BAdI activation for process enhancement
Preparation of SM59 connection
Technical user will be provided as dynamic parameter
Connectivity check & basic health check.

The following are configuration ⋅phases to setup the ‘Commit Registry’ approach on customer/target system:
Repository clone of BAdI logic since it is not part of software component SAP_BASIS
Endpoint ‘SCTS_GCTS_ENHANCEMENTS’
BAdI activation for process enhancement
Preparation of SM59 connection
Technical user will be provided as dynamic parameter
Connectivity check & basic health check.

Technical steps reflect similar logic for both source and target system. The endpoint name is different for end-to-end scenarios, and can be parameterized, too. Therefore, a one task list solution will be sufficient and can be provided with software component SAP_BASIS.

Customer and partner specific configuration for dedicated scenarios can be provided as parameter input in task list. This technical task list will prepare the commit registry specific setup and represents the second phase for the overall system preparation for gCTS.

Afterwards, the partner can start to create and clone the needed repositories, which should be available for development. The clone procedure of each repository requires a particular URL which can be applied from the remote repository which is located on the Partner-hosted Git Provider platform.

Once the clone was successfully executed and completely imported into the ABAP runtime, the partner can start to change related objects for required features. The changes will be still tracked in transport request.

The relation between transport request and repository can be realized by using transport layers which are subscribed to a non-ABAP system. The corresponding transport targets are observed by gCTS, and new commits will be automatically executed for newly released transport requests.

Usage of a BAdI workaround is also possible, to realize synchronous task-based committing. If the release of a transport request is started, the commit registry will be automatically used in the background and follows the process flow of FIG. 6 showing commit procedure on a source system.

Thus, the general process flow is not impacted for the partner. The partner can still make use of the default gCTS flow without any further activities.

The same expectation can be applied to the target system. There, a customer will simply consume the gCTS Fiori app in order to pull new changes/releases which are provided by partner.

The ‘Commit Registry’ will be automatically used during the import procedure and evaluates the pulled commit.

Partners can leverage common ‘Tag’ functionality of git in order to classify certain commits as deployable version. The ‘Tag’ approach is a popular solution and used by many Open-Source communities to publish releases. An enhancement in gCTS Fiori app may allow visualization of tag of commits.

Advanced branch handling with release branches is also possible. There, the partner will make use of branches to define new releases and to publish them to customers. Customers can pull the latest commit of the subscribed delivery branch in order to receive software updates.

While FIG. 1 shows a particular embodiment with the commit engine as being located outside the database, this is not required. Rather, alternative embodiments could leverage the processing power of an in-memory database engine (e.g., the in-memory database engine of the HANA in-memory database available from SAP SE), in order to perform one or more various functions as described above.

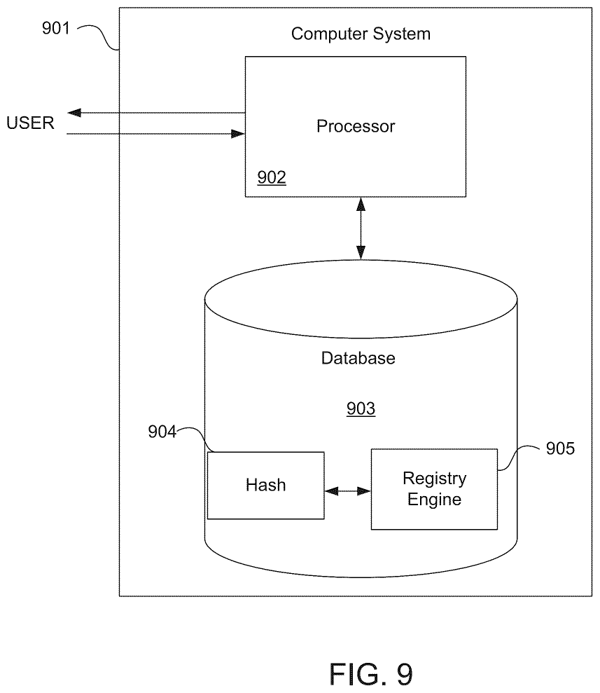

Thus FIG. 9 illustrates hardware of a special purpose computing machine configured to implement a code commit registry according to an embodiment. In particular, computer system 901 comprises a processor 902 that is in electronic communication with a non-transitory computer-readable storage medium comprising a database 903. This computer-readable storage medium has stored thereon code 905 corresponding to a registry engine. Code 904 corresponds to a hash. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

Embodiments as described herein may offer one or more advantages. One potential benefit is enhanced cooperation with prospective customers and vendors. That is, customers are free to engage vendors to develop valuable add-ons, which can then be relied on to operate seamlessly with a basic framework.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. Computer implemented systems and methods comprising:
a source receiving a request to deploy code to a target platform;
the source sending a commit to a repository;
the source receiving from the repository, a commit identifier;
the source calculating a registry hash from the commit; and
in response to receiving the request, the source writing the registry hash and the commit identifier as a registry entry within a register of a non-transitory computer readable storage medium.

Example 2. The computer implemented systems or methods of Example 1 wherein:
the source comprises a customer of the target system; and
the request to release code is sent by a developer of the customer.

Example 3. The computer implemented systems or methods of Example 2 wherein the commit includes an identifier of the developer.

Example 4. The computer implemented systems or methods of Examples 1, 2, or 3 further comprising:
the target platform receiving a request to import code;
the target platform reading the commit from the repository;
the target platform calculating a local hash from the commit;
the target platform reading the registry entry from the register;
the target platform comparing the local hash with the registry hash; and
the target platform importing the commit from the repository when the registry hash and the local hash match.

Example 5. The computer implemented systems or methods of Example 4 wherein the target platform references a commit history in importing the commit.

Example 6. The computer implemented systems or methods of Examples 4 or 5 wherein the target platform does not import the commit when the registry hash and the local hash do not match.

Example 7. The computer implemented systems or methods of Examples 4, 5, or 6 wherein the request to import code is received from a user of the target platform, the method further comprising:
the target platform sending a notification to the user when the first hash and the second hash do not match.

Example 8. The computer implemented systems or methods of Example 7 wherein notification includes ticket information.

Example 9. The computer implemented systems or methods of Examples 4, 5, 6, 7, or 8 wherein:
the non-transitory computer readable storage medium comprises an in-memory database; and
an in-memory database engine of the in-memory database,
   calculates the local hash, and
   compares the local hash to the registry hash.

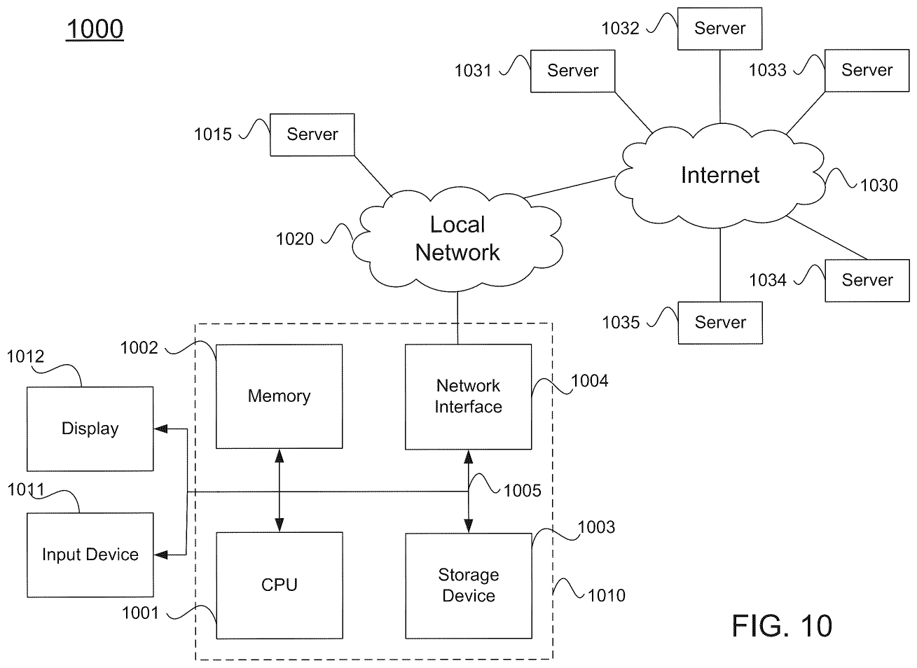

An example computer system 1000 is illustrated in FIG. 10. Computer system 1010 includes a bus 1005 or other communication mechanism for communicating information, and a processor 1001 coupled with bus 1005 for processing information. Computer system 1010 also includes a memory 1002 coupled to bus 1005 for storing information and instructions to be executed by processor 1001, including information and instructions for performing the techniques described above, for example. This memory may also be used for storing variables or other intermediate information during execution of instructions to be executed by processor 1001. Possible implementations of this memory may be, but are not limited to, random access memory (RAM), read only memory (ROM), or both. A storage device 1003 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1003 may include source code, binary code, or software files for performing the techniques above, for example. Storage device and memory are both examples of computer readable mediums.

Computer system 1010 may be coupled via bus 1005 to a display 1012, such as a Light Emitting Diode (LED) or liquid crystal display (LCD), for displaying information to a computer user. An input device 1011 such as a keyboard and/or mouse is coupled to bus 1005 for communicating information and command selections from the user to processor 1001. The combination of these components allows the user to communicate with the system. In some systems, bus 1005 may be divided into multiple specialized buses.

Computer system 1010 also includes a network interface 1004 coupled with bus 1005. Network interface 1004 may provide two-way data communication between computer system 1010 and the local network 1020. The network interface 1004 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1004 sends and receives electrical, electromagnetic, or optical signals that carry digital data streams representing various types of information.

Computer system 1010 can send and receive information, including messages or other interface actions, through the network interface 1004 across a local network 1020, an Intranet, or the Internet 1030. For a local network, computer system 1010 may communicate with a plurality of other computer machines, such as server 1015. Accordingly, computer system 1010 and server computer systems represented by server 1015 may form a cloud computing network, which may be programmed with processes described herein. In the Internet example, software components or services may reside on multiple different computer systems 1010 or servers 1031-1035 across the network. The processes described above may be implemented on one or more servers, for example. A server 1031 may transmit actions or messages from one component, through Internet 1030, local network 1020, and network interface 1004 to a component on computer system 1010. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
a source receiving a request to deploy code to a target platform;
the source sending a commit to a repository;
the source receiving from the repository, a commit identifier;
the source calculating a registry hash from the commit; and
in response to receiving the request, the source writing the registry hash and the commit identifier as a registry entry within a register of a non-transitory computer readable storage medium.

2. A method as in claim 1 wherein:
the source comprises a customer of the target system; and
the request to release code is sent by a developer of the customer.

3. A method as in claim 2 wherein the commit includes an identifier of the developer.

4. A method as in claim 1 further comprising:
the target platform receiving a request to import code;
the target platform reading the commit from the repository;
the target platform calculating a local hash from the commit;
the target platform reading the registry entry from the register;
the target platform comparing the local hash with the registry hash; and
the target platform importing the commit from the repository when the registry hash and the local hash match.

5. A method as in claim 4 wherein the target platform references a commit history in importing the commit.

6. A method as in claim 4 wherein the target platform does not import the commit when the registry hash and the local hash do not match.

7. A method as in claim 6 wherein the request to import code is received from a user of the target platform, the method further comprising:
the target platform sending a notification to the user when the first hash and the second hash do not match.

8. A method as in claim 7 wherein notification includes ticket information.

9. A method as in claim 1 wherein:
the non-transitory computer readable storage medium comprises an in-memory database; and
an in-memory database engine of the in-memory database,
calculates the local hash, and
compares the local hash to the registry hash.

10. A non-transitory computer readable storage medium embodying a computer program for performing a method, said method comprising:
receiving a request to import code from a source;
reading a registry hash from a registry entry of a registry, the registry entry written by the source and also including a commit identifier;
reading a commit from a repository;
calculating a local hash from the commit;
comparing the local hash with the registry hash; and
importing the commit from the repository when the registry hash and the local hash match.

11. A non-transitory computer readable storage medium as in claim 10 wherein a commit history is referenced in importing the commit.

12. A non-transitory computer readable storage medium as in claim 10 wherein the request to import is received from a user, the method further comprising:
when the when the registry hash and the local hash do not match,
not importing the commit from the repository, and
sending a notification to the user.

13. A non-transitory computer readable storage medium as in claim 12 wherein the notification comprises ticket information.

14. A non-transitory computer readable storage medium as in claim 10 wherein the commit includes an identifier of a developer.

15. A computer system comprising:
one or more processors;
a software program, executable on said computer system, the software program configured to cause an in-memory database engine of an in-memory database to:
receive a request to import code from a source;
read a registry hash from a registry entry of a registry stored in the in-memory database, the registry entry written by the source and also including a commit identifier;
read a commit from a repository;
calculate a local hash from the commit;
compare the local hash with the registry hash; and
import the commit from the repository when the registry hash and the local hash match.

16. A computer system as in claim 15 wherein the in-memory database engine is configured to reference a commit history to import the commit.

17. A computer system as in claim 15 wherein the in-memory database engine is configured to not import the commit when the first hash and the second hash do not match.

18. A computer system as in claim 17 wherein the request to import is received from a user, the in-memory database engine further configured to:
send a notification to the user.

19. A computer system as in claim 18 wherein the notification includes ticket information.

20. A computer system as in claim 15 wherein the commit includes a developer identifier.
